(19) United States
(12) Patent Application Publication
(10) Pub. No.: US 2026/0292544 A1
(43) Pub. Date: Sep. 24, 2026

(54) APPARATUSES AND METHODS FOR MACHINE LEARNING PREDICTION WINDOW PARAMETERS MANAGEMENT

(71) Applicant: Nokia Technologies Oy, Espoo (FI)

(72) Inventors: Jian SONG, Massy (FR); Hans Thomas HÖHNE, Espoo (FI); Ahmad MASRI, Tampere (FI); Muhammad Majid BUTT, Naperville, IL (US); Tachporn SANGUANPUAK, Oulu (FI); Vismika Maduka RANASINGHE MUDIYANSELAGE, Oulu (FI)

(21) Appl. No.: 19/475,540

(22) PCT Filed: May 29, 2024
(86) PCT No.: PCT/IB2024/055218

§ 371 Date: Oct. 15, 2025

(30) Foreign Application Priority Data
Jun. 15, 2023 (FI) 20235667

(51) Int. Cl. H04W 24/02; H04L 41/16

(52) U.S. Cl. CPC H04W 24/02; H04L 41/16

(57) ABSTRACT

Example embodiments provide an improved method for adapting a prediction window length of a user node. A computer-implemented method may comprise receiving, by a network node, one or more configuration requests from a user node for execution of one or more prediction window update related procedures; determining, by the network node, one or more parameters based on the one or more configuration requests, the one or more parameters corresponding to prediction window configuration information; and sending, by the network node, the one or more parameters to the user node. Apparatuses, methods, and computer programs are disclosed.

### TECHNICAL FIELD

The present application generally relates to wireless technology. Some example embodiments of the present application relate to adaptation and optimization of one or more prediction window parameters.

### BACKGROUND

Mobility management may be used to improve service-continuity in a communication network during mobility by minimizing call drops, radio link failures, unnecessary handovers, and/or handover ping-pong effects. In addition, for applications characterized with stringent quality of service requirements such as reliability, latency, etc., quality of experience may be sensitive to the handover performance. Thus, in mobility management it is desired to avoid unsuccessful handovers and to reduce latency during handover procedures. However, it may be challenging to achieve nearly zero-failure handover, for example, for a trial-and-error-based scheme.

Therefore, there is a need for enhancements for data collection, for example, for NR (new radio) and EN-DC (E-UTRA NR Dual connectivity).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may enable a user node to adapt a prediction window length for machine learning based prediction based on prediction window configuration information received from a network node. This may be achieved by the features of the independent claims. Further implementation forms are provided in the dependent claims, the description, and the drawings.

According to a first aspect, a network node may comprise at least one processor; and at least one memory including instructions which, when executed by the at least one processor, cause the network node at least to receive one or more configuration requests from a user node for execution of one or more prediction window update related procedures; determine one or more parameters based on the one or more configuration requests, the one or more parameters corresponding to prediction window configuration information; and send the one or more parameters to the user node.

According to an example embodiment of the first aspect, the prediction window configuration information may comprise at least one of an indication of a prediction window length, one or more criteria for evaluating the prediction window length, one or more thresholds for the one or more criteria, a prediction interval, an identifier of a machine learning model to be used by the user node for performing a prediction based on the prediction window configuration information, instructions for updating the prediction window length, or one or more adjustment parameters for updating the prediction window length.

According to an example embodiment of the first aspect, the at least one memory may further comprise instructions which, when executed by the at least one processor, cause the network node to obtain an evaluation result of the prediction window length based on the one or more criteria and the one or more thresholds, wherein the evaluation is at least one of received from the user node or performed by the network node; and send a message to the user node based on the evaluation result, the message comprising instructions to trigger a prediction window length update for a next prediction interval or continue predictions with the prediction window length.

According to an example embodiment of the first aspect, the at least one memory may further comprise instructions which, when executed by the at least one processor, cause the network node to receive, from the user node, a request for evaluation of the prediction window length; and send a response to the user node to initiate the evaluation.

According to an example embodiment of the first aspect, the message may be configured to trigger the user node to send a reconfiguration request for reconfiguration of the one or more parameters from the network node; and wherein the at least one memory further comprises instructions which, when executed by the at least one processor, cause the network node to receive the reconfiguration request from the user node; determine one or more updated parameters based on the reconfiguration request; and send the one or more updated parameters for the user node for the prediction window length update.

According to an example embodiment of the first aspect, the message may be configured to trigger the user node to perform the prediction window length update based on the one or more adjustment parameters.

According to an example embodiment of the first aspect, the indication of a prediction window length may comprise a predicted window length, and the at least one memory comprises instructions which, when executed by the at least one processor, cause the network node to configure a machine learning model to compute the predicted window length based on the one or more configuration requests.

According to an example embodiment of the first aspect, the indication of a prediction window length may comprise a rule for setting the prediction window length determined based on one or more radio communications related parameters.

According to an example embodiment of the first aspect, at least one of the configuration request or the reconfiguration request may comprise one or more measurements to be used by the network node for training the machine learning model configured to compute the predicted window length, and wherein the at least one memory comprises instructions which, when executed by the at least one processor, cause the network node to train the machine learning model based on the one or more measurements before sending the predicted window length.

According to a second aspect, a user node may comprise at least one processor; at least one memory including instructions which, when executed by the at least one processor, cause the user node at least to send one or more configuration requests to a network node for execution of one or more prediction window update related procedures; receive one or more parameters from the network node based on the one or more configuration requests, the one or more parameters corresponding to prediction window configuration information; and perform a prediction using a machine learning model based on the prediction window configuration information.

According to an example embodiment of the second aspect, the prediction window configuration information may comprise at least one of an indication of a prediction window length, one or more criteria for evaluating the prediction window length, one or more thresholds for the one or more criteria, a prediction interval, an identifier of the machine learning model, instructions for updating the prediction window length, or one or more adjustment parameters for updating the prediction window length.

According to an example embodiment of the second aspect, the at least one memory may further comprise instructions which, when executed by the at least one processor, cause the user node to receive a message from the network node, the message comprising instructions to trigger a prediction window length update for a next prediction interval or to continue prediction with the prediction window length based on an evaluation of the prediction window length; and perform the prediction window length update when triggered by the message.

According to an example embodiment of the second aspect, the at least one memory may further comprise instructions which, when executed by the at least one processor, cause the user node to evaluate the prediction window length based on the one or more criteria and the one or more thresholds; send an indication of the evaluation result to the network node; and wherein the message from the network node is received in response to the sent evaluation result.

According to an example embodiment of the second aspect, the indication of the evaluation result is provided as 1 bit information when the evaluation is performed based on a single criterion and as n-bit information when the evaluation is performed based on more than one criterion.

According to an example embodiment of the second aspect, the at least one memory may further comprise instructions which, when executed by the at least one processor, cause the user node to send a request for evaluation of the prediction window length to the network node; and receive a response from the network node to trigger the evaluation.

According to an example embodiment of the second aspect, the at least one memory may comprise instructions which, when executed by the at least one processor, cause the user node to send a reconfiguration request for one or more parameters to the network node based on the received message; receive from the network node one or more updated parameters; and update the prediction window length based on the one or more updated parameters.

According to an example embodiment of the second aspect, the message may comprise instructions to perform the prediction window length update based on the one or more adjustment parameters.

According to an example embodiment of the second aspect, the indication n of a prediction window length comprises a predicted window length, and at least one of the configuration request or the reconfiguration request may comprise one or more measurements to be used by the network node for training a machine learning model configured to compute the predicted window length before sending the predicted window length.

According to a third aspect, a computer-implemented method may comprise receiving, by a network node, one or more configuration requests from a user node for execution of one or more prediction window update related procedures; determining, by the network node, one or more parameters based on the one or more configuration requests, the one or more parameters corresponding to prediction window configuration information; and sending, by the network node, the one or more parameters to the user node.

According to an example embodiment of the third aspect, the prediction window configuration information may comprise at least one of an indication of a prediction window length, one or more criteria for evaluating the prediction window length, one or more thresholds for the one or more criteria, a prediction interval, an identifier of a machine learning model to be used by the user node for performing a prediction based on the prediction window configuration information, instructions for updating the prediction window length, or one or more adjustment parameters for updating the prediction window length.

According to an example embodiment of the third aspect, the method may comprise causing the network node to obtain an evaluation result of the prediction window length based on the one or more criteria and the one or more thresholds, wherein the evaluation is at least one of received from the user node or performed by the network node; and sending, by the network node, a message to the user node based on the evaluation result, the message comprising instructions to trigger a prediction window length update for a next prediction interval or continue predictions with the prediction window length.

According to an example embodiment of the third aspect, the method may comprise causing the network node to receive, from the user node, a request for evaluation of the prediction window length; and sending, by the network node, a response to the user node to initiate the evaluation.

According to an example embodiment of the third aspect, the message may be configured to trigger the user node to send a reconfiguration request for reconfiguration of the one or more parameters from the network node; and wherein the method further comprises causing the network node to receive the reconfiguration request from the user node; determining, by the network node, one or more updated parameters based on the reconfiguration request; and sending, by the network node, the one or more updated parameters for the user node for the prediction window length update.

According to an example embodiment of the third aspect, the message may be configured to trigger the user node to perform the prediction window length update based on the one or more adjustment parameters.

According to an example embodiment of the third aspect, the indication of a prediction window length may comprise a predicted window length, and the method may comprise causing the network node to configure a machine learning model to compute the predicted window length based on the one or more configuration requests.

According to an example embodiment of the third aspect, the indication of a prediction window length may comprise a rule for setting the prediction window length determined based on one or more radio communications related parameters.

According to an example embodiment of the third aspect, at least one of the configuration request or the reconfiguration request may comprise one or more measurements to be used by the network node for training the machine learning model configured to compute the predicted window and length, wherein the method comprises causing the network node to train the machine learning model based on the one or more measurements before sending the predicted window length.

According to a fourth aspect, a computer-implemented method may comprise sending, by a user node, one or more configuration requests to a network node for execution of one or more prediction window update related procedures; receiving, by the user node, one or more parameters from the network node based on the one or more configuration requests, the one or more parameters corresponding to prediction window configuration information; and performing, by the user node, a prediction using a machine learning model based on the prediction window configuration information.

According to an example embodiment of the fourth aspect, the prediction window configuration information may comprise at least one of an indication of a prediction window length, one or more criteria for evaluating the prediction window length, one or more thresholds for the one or more criteria, a prediction interval, an identifier of the machine learning model, instructions for updating the prediction window length, or one or more adjustment parameters for updating the prediction window length.

According to an example embodiment of the fourth aspect, the method may comprise causing the user node to receive a message from the network node, the message comprising instructions to trigger a prediction window length update for a next prediction interval or to continue prediction with the prediction window length based on an evaluation of the prediction window length; and performing, by the user node, the prediction window length update when triggered by the message.

According to an example embodiment of the fourth aspect, the method may comprise causing the user node to evaluate the prediction window length based on the one or more criteria and the one or more thresholds; sending, by the user node, an indication of the evaluation result to the network node; and wherein the message from the network node is received in response to the sent evaluation result.

According to an example embodiment of the fourth aspect, the indication of the evaluation result may be provided as 1 bit information when the evaluation is performed based on a single criterion and as n-bit information when the evaluation is performed based on more than one criterion.

According to an example embodiment of the fourth aspect, the method may comprise causing the user node to send a request for evaluation of the prediction window length to the network node; and receiving, by the user node, a response from the network node to trigger the evaluation.

According to an example embodiment of the fourth aspect, the method may comprise causing the user node to send a reconfiguration request for one or more parameters to the network node based on the received message; receiving, by the user node from the network node, one or more updated parameters; and updating, by the user node, the prediction window length based on the one or more updated parameters.

According to an example embodiment of the fourth aspect, the message may comprise instructions to perform the prediction window length update based on the one or more adjustment parameters.

According to an example embodiment of the fourth aspect, the indication of a prediction window length comprises a predicted window length, and at least one of the configuration request or the reconfiguration request may comprise one or more measurements to be used by the network node for training a machine learning model configured to compute the predicted window length before sending the predicted window length.

According to a fifth aspect, a computer program may be configured, when executed by a processor, to cause a network node at least to perform the following: receive one or more configuration requests from a user node for execution of one or more prediction window update related procedures; determine one or more parameters based on the one or more configuration requests, the one or more parameters corresponding to prediction window configuration information; and send the one or more parameters to the user node. The computer program may further comprise instructions for causing the network node to perform any example embodiment of the method of the third aspect.

According to a sixth aspect, a network node may comprise means for receiving one or more configuration requests from a user node for execution of one or more prediction window update related procedures; determining one or more parameters based on the one or more configuration requests, the one or more parameters corresponding to prediction window configuration information; and sending the one or more parameters to the user node. The network node may further comprise means for performing any example embodiment of the method of the third aspect.

According to a seventh aspect, a computer program may comprise instructions for causing a user node to perform at least the following: send one or more configuration requests to a network node for execution of one or more prediction window update related procedures; receive one or more parameters from the network node based on the one or more configuration requests, the one or more parameters corresponding to prediction window configuration information; and perform a prediction using a machine learning model based on the prediction window configuration information. The computer program may further comprise instructions for causing the user node to perform any example embodiment of the method of the fourth aspect. According to an eighth aspect, a user node may comprise means for sending one or more configuration requests to a network node for execution of one or more prediction window update related procedures; receiving one or more parameters from the network node based on the one or more configuration requests, the one or more parameters corresponding to prediction window configuration information; and performing a prediction using a machine learning model based on the prediction window configuration information. The user node may further comprise means for performing any example embodiment of the method of the fourth aspect.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to explain the example embodiments. In the drawings:

FIG. 1 illustrates an example of a communication network comprising network nodes and at least one client node according to an example embodiment.

FIG. 2 illustrates an example of an apparatus configured to practice one or more example embodiments;

FIG. 3 illustrates an example block diagram of a network node configured to select a prediction window length to be used by a user node according to an example embodiment;

FIG. 4 illustrates an example flow chart for determining and updating a machine learning prediction window by a user node, according to an example embodiment;

FIG. 5 illustrates an example of a machine learning model structure for prediction window according to an example embodiment;

FIG. 6 illustrates an example of a message sequence chart for prediction window length update based on a rule-based mechanism according to an example embodiment;

FIG. 7 illustrates an example of a message sequence chart for prediction window length update by using a machine learning window configuration predictor according to an example embodiment;

FIG. 8 illustrates an example application of a machine learning-based window configuration predictor for window length prediction according to an example embodiment;

FIG. 9 illustrates an example model structure of a machine learning window configuration predictor according to an example embodiment;

FIG. 10 illustrates an example structure of a single LSTM neural node within hidden layers of a machine learning model structure according to an example embodiment;

FIG. 11 illustrates an example of a method of enabling prediction window updates according to an example embodiment;

FIG. 12 illustrates an example of another method of enabling prediction window updates according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present examples may be constructed or utilized. The description sets forth the functions of the example and a possible sequence of operations for constructing and operating the example. However, the same or equivalent functions and sequences may be accomplished by different examples.

An objective of this disclosure is to enable a user equipment (UE) to adapt a prediction window length of a deployed machine learning (ML) model based on at least one of one or more configurations or one or more criterion obtained from the network. Hence, mobility related decision-making, such as LTM, may be improved.

A prediction window may be also referred to as a sequence-to-sequence prediction. The sequence-to-sequence prediction may involve predicting an output sequence given an input sequence. A use of prior time steps to predict the next time step may be referred to as a sliding window prediction.

Example embodiments may enable to at least one of initially set prediction window related parameters based on, for example, the radio environment and mobility profiles or other constraints, adapt prediction window length based on determined criteria to deal with a tradeoff between agreed key performance indicators satisfaction and/or prediction insight, determine evaluation criteria and time constraints for a current window length, determine if another separate machine learning-based functionality can be useful to supervise the prediction window length adjustment, or provide a new signaling mechanism for adaption and optimization of the prediction window related parameters.

An example embodiment may provide enhancements to signaling procedures and exchanged control messages between a network node and a user node. The enhancements may enable to adapt a prediction window length more optimally by using at least one of rule-based mechanism or ML-based window configuration predictor.

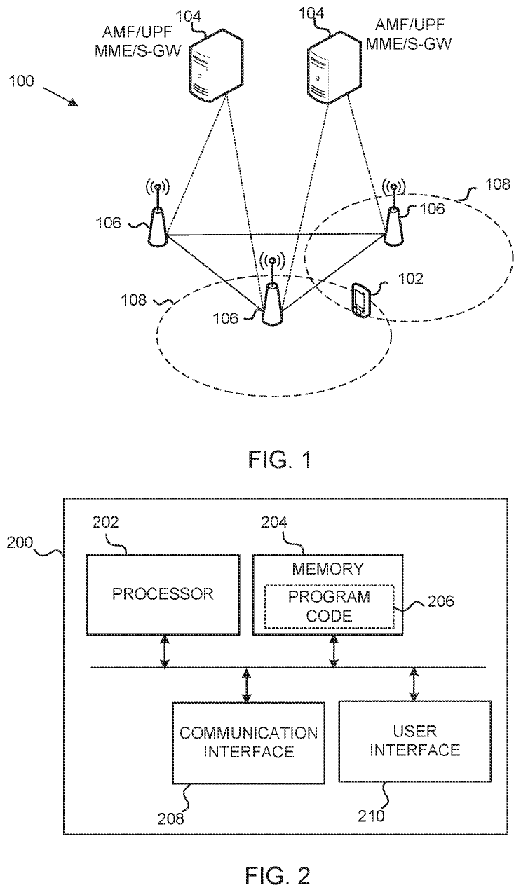

FIG. 1 illustrates an example of a communication network 100 comprising network nodes and at least one client node. The communication network 100 may comprise one or more core network elements 104 such as for example access and mobility management function (AMF) and/or user plane function (UPF), one or more base stations, represented by gNBs 106. The communication network 100 may further comprise one or more client nodes, which may be also referred to as user nodes, user terminals, or UE 102. The UE 102 may communicate with one or more of the base stations via wireless radio channel(s). Communications between the UE 102 and gNB 106 may be bidirectional. Hence, any of the devices may be configured to operate as a transmitter and/or a receiver.

Network nodes may be associated with respective coverage areas 108. When the UE 102 moves from one coverage area to another coverage area, the network 100 may be configured to perform a handover (HO) from a source network node to a target network node, or another prepared target network node.

The base stations may be configured to communicate with the core network elements over a communication interface, such as for example a control plane interface or a user plane interface NG-C/U. Functionality of a base station may be distributed between a central unit (CU), for example a gNB-CU, and one or more distributed units (DU), for example one or more gNB-DUs. Base stations may be also called radio access network (RAN) nodes and they may be part of a radio access network between the core network and the UEs. Network elements such as AMF/UPF, gNB, gNB-CU and gNB-DU may be generally referred to as network nodes or network devices. Although depicted as a single device, a network node may not be a stand-alone device, but for example a distributed computing system coupled to a remote radio head.

The communication network 100 be may configured for example in accordance with the 5th Generation digital cellular communication network, as defined by the 3rd Generation Partnership Project (3GPP). In one example, the communication network 100 may operate according to 3GPP 5G-NR. It is however appreciated that example embodiments presented herein are not limited to this example network and may be applied in any present or future wireless or wired communication networks, or combinations thereof, for example other type of cellular networks, short-range wireless networks, broadcast or multicast networks, or the like.

Mobility performance of a UE may be increased by a use of artificial intelligence and/or machine learning solutions. For example, a ML model located at the network may receive radio measurements as an input from the UE, predicted resource status of neighboring RAN nodes and UE trajectory prediction. The UE trajectory prediction may comprise, for example, latitude, longitude, altitude, cell ID and beam ID of UE over a future period of time. The inputs can be used to predict the handover target node.

LTM may refer to L1/L2-triggered mobility. LTM may be performed by a MAC layer terminated in the distributed unit (DU). For example, LTM may be performed between a serving cell in a first DU and a target cell in a second DU in an inter-DU intra-CU scenario. The same would apply to an intra-DU intra-CU scenario, wherein the first DU would be the same as the second DU.

During a preparation phase for LTM, a network may decide to configure potential target cells for LTM based on a measurement report received from the UE. The network may then send a RRC configuration for LTM to the UE. Radio resource control (RRC) may refer to provision of radio resource related control data. After confirming the RRC configuration to the network, the UE may start to report periodically L1 beam measurements of serving and candidate target cells. Upon determining that there is a candidate target cell having a better radio link beam measurement than the serving cell, e.g., L1-RSRP of target beam measurement being greater than L1-RSRP of serving cell measurement with an offset for, for example, time-to-trigger (TTT) time, the serving cell may send a MAC control element (MAC CE) or a L1 message to trigger the cell change to the candidate target cell. Thereafter, a handover from the serving cell to the target cell may be executed by the UE.

A benefit of LTM compared to baseline handover and conditional handover is that the interruption during handover execution can be reduced as the UE may not need to perform higher layer (RRC, PDCP) reconfiguration, and for some scenarios, the UE can perform a RACHless HO to connect to the target cell.

In radio mobility scenarios such as in ML-aided mobility management, e.g., the LTM, a prediction that spans over a window of time may be performed that allows to extract a sequence of predictions of target variables. The predictions may be performed, for example, by the UE 102. The target variables may comprise, for example, beam IDs and associated RSRP values for HO decision making. With the prediction, additional degrees of freedom in terms of robustness may be introduced for more flexible and proactive mobility management. However, the following issues may need to be addressed before applying the ML-based functionality.

System state based adaptivity considers for how long the future prediction window should be from a perspective of system performance. Shorter prediction windows may be sufficient for high-speed mobility as more handover (HO) related events may happen in a shorter time span. However, a functional relation may need to be established. On contrary, longer prediction windows can be applied in a quasi-stationary/slow moving environment, for example.

Performance gain versus ML prediction accuracy tradeoff may be used to estimate for how long the prediction window in the future time scale would be to ensure more accurate decision making. Theoretically, the longer the prediction window, the better insights can be obtained, i.e., the longer the window, the more the future can be estimated and used to plan decisions accordingly. However, longer prediction window may require more predictions based on history. Further, a likelihood of correlation of history with future prediction may decrease as number of future prediction increases. Applying poor prediction in a relatively large time window may lead to inappropriate mobility decision such as falling in a radio link failure due to a bad HO decision.

Based on the above tradeoffs, there is a need for criteria to be applied to determine the prediction window length. For example, if prediction window length is adjusted in an adaptive way, the criteria may comprise how often or how much the window needs to be adjusted. One option is to use dynamic continuous adjustment. Dynamic continuous adjustment can lead to better results, but the cost of adjustment may be high in terms of coordination between UEs and the network (NW). Another option may be periodic adjustment. Periodic adjustment may result in worse performance as compared to dynamic continuous adjustment (as performance may suffer before start of next period) but it may be more practical. Performance of the periodic adjustment may be improved by reducing periodicity if environment is dynamic.

FIG. 2 illustrates an example of an apparatus 200 configured to practice one or more example embodiments.

The apparatus 200 may comprise at least one processor 202. The at least one processor 202 may comprise, for example, one or more of various processing devices, such for as example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 200 may further comprise at least one memory 204. The at least one memory 204 may be configured to store, for example, computer program code 206 or the like, for example operating system software and application software. The memory 204 may comprise one or more volatile memory devices, one or more non-volatile memory devices, and/or a combination thereof. For example, the memory 204 may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 200 may further comprise one or more communication interfaces 208 configured to enable the apparatus 200 to transmit information to other devices. The one or more communication interfaces 208 may be also configured to enable the apparatus 200 to receive information from devices. The other communication interface 208 may be configured to provide at least one wireless radio connection, such as for example a 3GPP mobile broadband connection (e.g. 3G, 4G, 5G). However, the communication interface 208 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface 208 may comprise, or be configured to be coupled to, at least one antenna to transmit and/or receive radio frequency signals. One or more of the various types of connections may be also implemented as separate communication interfaces, which may be coupled or configured to be coupled to a plurality of antennas.

The apparatus 200 may further comprise a user interface 210 comprising an input device and/or an output device. The input device may take various forms such a keyboard, a touch screen, or one or more embedded control buttons. The output device may for example comprise a display, a speaker, a vibration motor, or the like.

When the apparatus 200 is configured to implement some functionality, some component and/or components of the apparatus 200, such as for example the at least one processor 202 and/or the memory 204, may be configured to implement this functionality. Furthermore, when the at least one processor 202 is configured to implement some functionality, this functionality may be implemented using program code 206 comprised, for example, in the memory 204.

The functionality described herein may be performed, at least in part, by one or more computer program product components such as software components. According to an embodiment, the apparatus 200 comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAS), application-specific Integrated Circuits (ASICs), application-specific Standard Products (ASSPs), System-on-a-chip systems (SOCs), Complex Programmable Logic Devices (CPLDs), Graphics Processing Units (GPUS).

The apparatus 200 may comprise means for performing at least one method described herein. In one example, the means comprises the at least one processor 202, the at least one memory 204 including instructions configured to, when executed by the at least one processor 202, cause the apparatus 200 to perform the method.

The apparatus 200 may comprise for example a computing device such as for example a base station, a server device, a mobile phone, a tablet computer, a laptop, or the like. The apparatus 200 may comprise, for example, a client node, such as for example the UE 102. In one example, the apparatus 200 may comprise, for example, a network node. The network node may be, for example, a 5G node, such as the gNB 106. In one example, the apparatus 200 may comprise a vehicle such as for example a car. Although the apparatus 200 is illustrated as a single device it is appreciated that, wherever applicable, functions of apparatus 200 may be distributed to a plurality of devices.

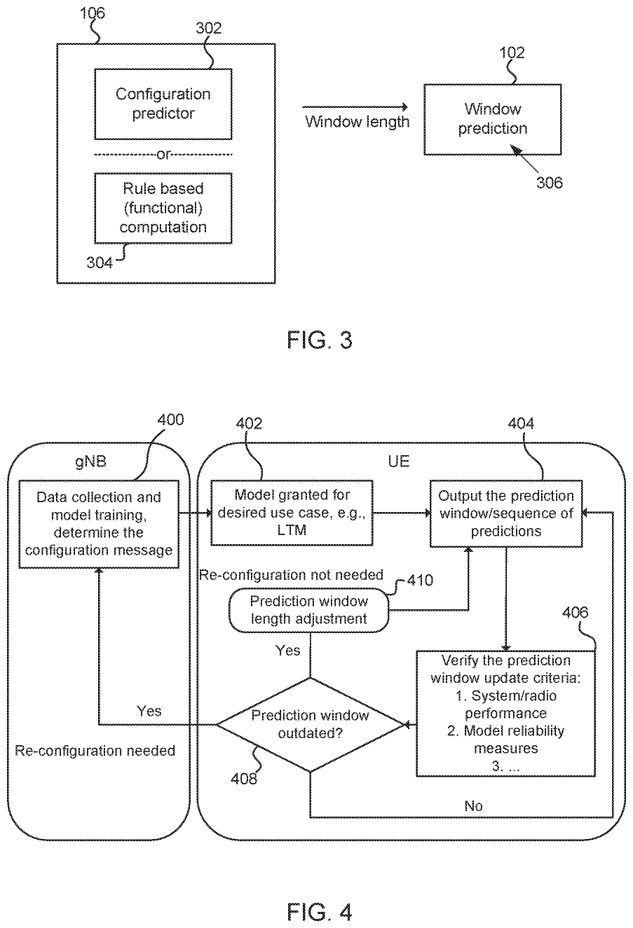

FIG. 3 illustrates an example block diagram of a network node configured to select a prediction window length to be used by a user node according to an example embodiment.

An example embodiment may provide a method for adaptive prediction window length optimization between a radio network, i.e., a gNB 106 and a user node, i.e., a UE 102. In an example embodiment, the gNB 106 may be configured to control the prediction window length grant/update for an ML prediction model at the UE side 102. The gNB 106 may be configured to perform the prediction window length selection based on one or more rules-based computation 304 or based on a ML model 302. The gNB 106 may be configured to send an indication of the selected prediction window length to the UE 102 for predictions by a second ML model 306.

Enhancements and extension of RRC specifications may be provided by using ML prediction window adaptation related configuration information and related implementation procedures. Further, an extension of an IE (information element) of report configuration exchanged through RRC configuration messages may be provided. The gNB may be configured to determine one or more configuration parameters for the prediction window and/or its update. The parameters may comprise at least one of: 1) a prediction interval, 2) a prediction window length/duration L_{pred}, 3) updating criteria to adapt the prediction window length based on some constraints. When determining the prediction window length update, both rules/policy-based mechanism and ML-based functionality can be used with different implementation steps and signaling configurations.

The prediction window update procedure for rule-based mechanism may be conducted at both the UE 102 and gNB 106 in static and/or semi-static way. In the static approach, an RRC reconfiguration procedure may be requested, while semi-static method may be applied in a more dynamic way with reduced signaling overhead.

The prediction window update procedure for ML-based solution may rely on a ML model, namely ML window configuration predictor. Depending on evaluation constraints, model retraining or update for prediction window configuration may be also considered.

Depending timing constraints, the on parameters for prediction window adaptation configuration may be conveyed by RRC/L3 channels. Indication reporting signals, e.g., evaluation outcome and feedback for prediction window update, and dynamic adjustment parameters may be communicated via L1/L2 signaling channels between the gNB 106 and the UE 102.

There may be two ML-based functionalities in the proposed framework. The first ML model 302 may be configured to predict the window length/duration. The first ML model 302 may be referred to as the ML-based window configuration predictor. The gNB 106 may be configured to run the ML-based window configuration predictor for more sophisticated NW wide knowledge. An output of the first ML model 302 may comprise at least one of a prediction window length or duration. An input to the first ML model may comprise, for example, at least one of a network observed performance or a UE model confidence.

The second ML model 306 may be configured to perform the prediction window output. The UE 102 may be configured to run the second ML model 306 for a desired use case. The use case may comprise, for example, mobility management for BHO (baseline HO), CHO (conditional HO) or LTM, etc. An output of the second ML 306 model may comprise a sequence of RSRP measurement samples from beams and/or cells. The output can be also a time sequence (window) of K-strongest beams (K=1, 2, 4 . . . ), for example. The output can be a list of predicted mobility-related events (serving beam becomes stronger than neighbour, neighbour becomes stronger than threshold, etc.) The second ML model may be also used for the rule-based mechanism.

For example, the first ML model 302 may be used to predict a stability duration of a current environment to aid the second ML model 306 to perform a prediction that spans over a window of time matching the prediction of the first ML model 302 about the duration of the stability of the environment.

The first ML model 302 may be trained and used at the gNB side 106. The second ML model 306 may be trained and transferred to the UE 102. Alternatively, the second ML model 306 may be trained and used at the UE 102. It is assumed that a UE is capable of hosting and/or performing the ML related training and/or inference.

Although subjects may be referred to as ‘first’ or ‘second’ subjects, this does not necessarily indicate any order or importance of the subjects. Instead, such attributes may be used solely for the purpose of making a difference between subjects.

FIG. 4 illustrates an example flow chart for determining and updating a machine learning prediction window by a user node, according to an example embodiment.

At 400, a network node, such as a gNB, may be configured to perform pre-configuration and processing. The gNB may be configured to generate a ML prediction window related configuration message. The configuration message may comprise one or more parameters determined by the gNB. The one or more parameters may be configured to allow a UE to perform the update and adjustment of prediction window if needed. The gNB may be configured to perform data generation, data collection, and model training based on availability of source data. The ML model may be then transferred by the gNB to the UE for inference. There are various options regarding hosting of ML model, training, inference, and model transfer, but these topics are out of scope of this disclosure.

At 402, the UE may be configured to deploy the ML model. The UE may be configured to take the granted model from the gNB or use a locally trained model for the desired use case, e.g., BHO or LTM.

At 404, the UE may be configured to initiate an inference mode. During the inference mode, the UE may be configured to output the prediction window or a sequence of predictions. The predictions may comprise, for example, beam RSRPs for proactive decision-making in mobility management. The prediction window length of the prediction model may be initially configured by the gNB.

At 406, the UE may be configured to perform one or more prediction window length verification procedures. An objective of the procedures is to examine whether the current prediction window is sufficient or need to be adjusted/updated. Evaluation or assessment criteria for the current prediction window can be defined based on a model reliability or system performance in the determined use case. The UE may be configured to obtain one or more criteria and respective thresholds for performing the evaluation. Alternatively, or in addition, the UE may be configured to receive an evaluation result from the gNB.

At 408, the UE may be configured to verify based on the evaluation criteria and/or the received evaluation result whether it is time to update the prediction window length. If no, the UE may be configured to continue the inference phase at 404 for the next prediction interval.

If yes, either a static or a semi-static approach may be applied. In the static approach, the UE may be configured to request a reconfiguration message from the gNB. The reconfiguration message may comprise new prediction window settings. In the semi-static (dynamic) approach, the UE may be configured to perform at 410 self-adjustment of the prediction window. The self-adjustment may be performed, for example, based on the predefined parameters received at 400.

At 410, the UE may be configured to adjust the prediction window length. Thereafter, the UE may be configured to continue the inference phase for the next prediction interval, at 404.

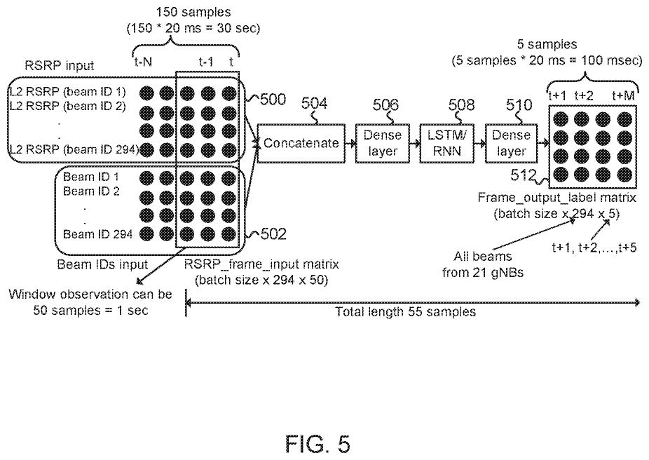

FIG. 5 illustrates an example of a machine learning model structure for prediction window according to an example embodiment. The ML model or algorithm may be configured to perform a sequence/window of output in a future time domain. The ML model may be configured to operate at a UE.

The ML model structure may comprise an input frame 500 with a sequence of L2/RSRP and/or an input frame 502 with a sequence of beam IDs from serving and neighboring cells. The ML model may be configured to concatenate at 504 the input frames 500, 502 before the inputs are fed into the ML model for inference. The ML model may comprise, for example, a long-short-term-memory (LSTM) recurrent neural network (RNN) 508 configured to obtain a time sequence output. The ML model may further comprise one or more dense layers 506, 510 configured to help in changing the dimensionality of the output from the preceding layer so that the ML model can more easily define the relationship between the values of the data in which the ML model is working. In one example, L2-RSRP input values may be obtained by the ML model from 294 beams (14 beams from 21 gNBs) within 3 second. The gNB may be configured to measure SSB every 20 ms and the measurement may be for 150 samples, such that the total input length is 3 second. The output 512 of the ML model can be any of predicted L2-RSRP values, or key markers, e.g., HO indicator metric/predicted HO events within the prediction window. A benefit of the example ML model is that it may allow to deliver an additional information in terms of beam/cell selection on top of a mobility management framework in L1/L2 and/or L3.

For example, the input sequence at time t may be denoted as (Qₜ₋₁, . . . , Q_{t-N}). Each sample Q may comprise:

$$Q = \{ r , b \} = \{ \{ {r}_{1} , {r}_{2} , … , {r}_{294} \} , \{ {b}_{1} , {b}_{2} , … , {b}_{294} \} \} ,$$

where r={r₁, r₂, . . . , r₂₉₄} is the input RSRP vector measured from 294 beams (14 beams from 21 gNBs), i.e., b={b₁, b₂, . . . , b₂₉₄}. The input frame may be measured from past N ms that contains q past samples for each measurement or beam ID. In this example, gNB measures SSB every 20 ms and q=150 measurement samples are collected within the total input length N=3000 ms. The example input data is thus a 150×588 matrix.

Labeled data used to train the ML model may comprise the sequence of RSRP samples in a given prediction window M ms that contains m past samples for each measurement or beam ID. For example, the prediction output may be the RSRP measured from 294 beams (14 beams from 21 gNBs) in M=100 ms that include m=5 samples for each index. The label data may be thus a 294×5 matrix of (Pₜ₊₁, . . . . P_{t+M}).

A time series prediction model may be implemented to learn the dependencies of historical RSRP plus each beam index (Qₜ₋₁, . . . , Q_{t-N}) over the future RSRP values (Pₜ₊₁, . . . . P_{t+M}). The LSTM may provide an effective approach to tackle the long-range dependencies problem. The ML model may comprise a set of parameters θ_{(i,j)}, associated with each input Qᵢ. Earlier θ_{(i,⋅)} may be multiplied with a weight and added to a later one, to capture the time series dependencies. An output layer θ_{(⋅,l)} of the ML model may be associated with each label Pᵢ. A loss function may be defined to evaluate the error between a model predicted \hat{P} and detected P, for example:

$$e ( \hat{P} , P ) = \frac{1}{k} {\sum }_{i = 1}^{k} {( {J}_{i} ( \hat{P} \vert Q , θ ) - {P}_{i} )}^{2} .$$

In the training process, an optimization algorithm like Stochastic Gradient Descend (SGD) can be applied to tune each θ_{(i,j)}, such that the average prediction error of samples collected from the UE can be minimized. The model reliability evaluation and assessment may be conducted when training steps are completed.

Next, selection of one or more parameters performed by a gNB for configuration of ML prediction window adaption is described. In an embodiment, a UE may be configured to perform a prediction window based on a configuration message with the one or more parameters sent from the gNB. The configuration parameters may comprise, for example, new RRC parameters.

For example, the gNB may be configured to determine a ML model prediction interval. The interval may be expressed, for example, in ms. Depending on the scenario and use case, the prediction interval may be aligned with the time constraints and granularity of the protocol layers, or measurement reporting interval. For instance, if LTM is used, the prediction interval can be 10-20 ms. For another example, the prediction interval can be 100-200 ms if BHO is applied and triggered by a RRC layer.

The gNB may be configured to determine a ML model prediction window length/duration L_{pred}. The prediction window length may be configured, for example, as a function of the radio communication scenario. For example, the prediction window length may be determined by the gNB based on a HO interruption time. The HO interruption time can be configured by higher layers, or the HO interruption time can be an average value observed in the cell for UEs of similar speed (signalled by the network). The HO interruption time could also be obtained by the gNB based on an average value that the UE observed for itself. For example, in case of a BHO, the HO interruption time may be 300 ms. The HO interruption time is of interest as a parameter for prediction window length as it will influence selecting HO targets within a predicted window. A shorter HO interruption time may allow setting of a shorter prediction window length, for example, when the target is to avoid unnecessary HO.

The gNB may be also configured to determine the prediction window length based on an association time of staying (ToS) in beams or in cells, divided by the number of beam or cell switches. The ToS can be an observed average value in the cell for UEs of similar speed or trajectory (past beam IDs). A shorter ToS may allow short prediction window length. Thus, an example prediction window setting rule at the UE may be:

$${L}_{pred} = max \{ \frac{Mean ToS}{2} , mean HO interruption time \} .$$

The gNB may be configured to send to the UE at least an indication of the prediction window length to be used by the UE. The indication may comprise, for example, a value for the prediction window length. The value may be computed based on the rule. Alternatively, the indication may comprise the rule for setting the prediction window length.

The gNB may be also configured to determine the prediction window length based on a speed of the UE derived from Doppler spread. For example, the gNB may be configured to determine shorter prediction window length for higher speeds of the UE.

The gNB may be further configured to determine the prediction window length based on other available information at the gNB, such as cell configuration including Inter-Site-Distance (ISD), antenna panel configuration, etc.

The gNB can also be configured to determine updating criteria to adapt the prediction window length based on one or more constraints.

The criteria may comprise, for example, system KPIs (key performance indicators) from the gNB/NW, denoted as Qₛ. The system KPIs may comprise, for example, at least one of an outage probability, a system reliability, an amount of out of sync (OOS), an amount of beam failure instance (BFI), cell throughput, etc. As an example, the gNB may configure a threshold γₛ to indicate the system KPI satisfactory ratio with respect to the current prediction window configuration.

The criteria may be also determined based on model reliability assessment from the UE, denoted as Qₘ. The reliability assessment may be based, for example, prediction accuracy, confidence, etc. As an example, the gNB may configure a threshold γₘ to indicate the model reliability satisfactory ratio with respect to the current window configuration.

An updating rule for adapting the prediction window length may be based on a static or a semi-static approach. In the static approach, the UE may be configured to request RRC reconfiguration for relevant parameter and policy settings. For example, the update condition may be triggered by at least one of Qₛ<γₛ or Qₘ<γₘ.

In the semi-static approach, the UE may not request RRC reconfiguration for the relevant parameter and policy settings. In an example, the update condition may be triggered by at least one of Qₛ<γₛ or Qₘ<γₘ. In the semi-static approach, the UE may be configured to adjust the prediction window length based on one or more parameters received from the gNB, such as an offset value ±Δ_{win}. The offset value may be received, for example, with the configuration message or with the message triggering the update procedure.

In another example of the rule-based setting of prediction window length, adaptivity may be achieved with feedback by the network. For instance, the prediction window length may be formulated as:

$${L}_{pred} = ρ \times max \{ \frac{Mean ToS}{2} , mean HO interruption time \} ,$$

where ρ is a constant which is updated by the network based on network observed performance.

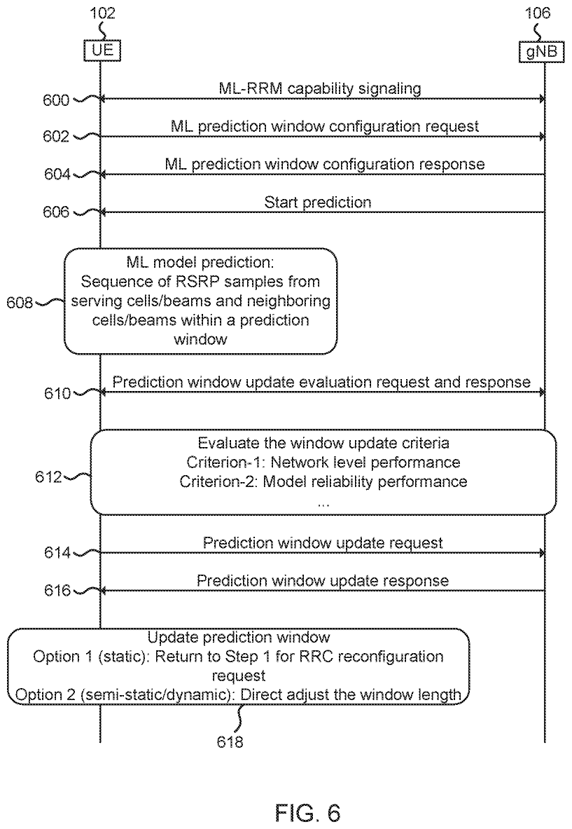

FIG. 6 illustrates an example of a message sequence chart for prediction window length update based on a rule-based mechanism according to an example embodiment. The signalling may be performed between a network node, such as a gNB 106, and a user node, such as a UE 102.

At 600, the UE 102 and the gNB 106 may be configured to perform capability exchange for ML-based radio algorithms. For example, the UE 102 may be configured to request from the gNB 106 the ML-based functionalities to support a target use case, e.g., LTM.

At 602, the UE 102 may be configured to request one or more configurations from the gNB 106 to be used for execution of one or more ML prediction window update and optimization related procedures. The gNB 106 may respond with a configuration message comprising information for the one or more configurations.

The requested configuration message may include a ML model ID or ML-related algorithm ID for ML model prediction to be performed at 608. When the UE 102 is equipped with ML-based functionalities, the ID for ML model or ML-related algorithm may be optional. As described above, the ML model training, inference, and transfer process are not within the scope of this disclosure. It is assumed that the UE is capable of running a ML prediction window related method.

The signaling 600 and 602 may be comprised in the same message. That is, the gNB 106 may determine the ML prediction window configurations response based on the UE's capability signaling. The capability signaling from the UE may occur at the time when UE is connecting to the network. The capability of the UE may become part of a network-stored UE context, and it may be transferred from gNB to gNB during mobility, such that the UE does not need to send it to every gNB separately. The signaling response 604 may be sent as soon as the UE is served by the gNB. It may be sent when the gNB determines that the UE's window prediction capability is useful, for instance when the UE is entering radio conditions suitable for the capability. The radio conditions may be those of being at cell edge and/or radio channel exhibiting a certain speed.

In addition, or alternatively, the requested configuration message may comprise one or more other parameters related to prediction window configuration information.

The ML prediction window configuration related parameters may comprise an ML model prediction interval. The ML model prediction interval may be determined by the gNB 106 based on time constraints and granularity of the protocol layers or measurement reporting interval, for example. The ML prediction window configuration related parameters may further comprise a prediction window with length L_{pred} to output predicted samples in future time scale. The prediction window may be a sliding window.

The requested configuration message may further comprise one or more criteria for ML prediction window update. The one or more criteria may be based on, for example, at least one of system KPI related measures Qₛ or model reliability related measures Qₘ.

Upon each criterion, one or more thresholds, namely system KPI satisfactory ratio γₛ, and model reliability satisfactory radio γₘ, can be generated by the gNB 106 to UE 102 for evaluation of prediction window update condition and criteria. The update may be triggered based on the one or more criteria as a standalone method or joint evaluation.

The updating policy may be static, e.g., based on RRC reconfiguration, or semi-static with relevant parameters. The relevant parameters may comprise, for instance, a set of offset values {±Δ_{win},0}. The configuration message may comprise instructions for updating the prediction window length according to the updating policy determined by the gNB.

The signalling channel to be used, or a protocol layer to be used, e.g., RRC or MAC, may be selected depending on the time constrains of the prediction window update, prediction window optimization related evaluation execution, data collection, and/or feedback indication, and the like.

At 604, the gNB 106 may be configured to send one or more configuration parameters to be used for the execution of one or more ML prediction window update and optimization related procedures as requested by the UE at 602. The configuration parameters may comprise one or more parameters corresponding to prediction window configuration information, such as an indication of the prediction window length, the one or criteria for evaluation of the prediction window length and/or the one or more thresholds for the one or more criteria. The same signaling channel or protocol layer, e.g., RRC or MAC, may be used as described at 602. The gNB 106 may be configured to transmit to the UE 102 the configuration message determined by the gNB at 602 for follow-up prediction window update procedures. The gNB 106 may be configured to define and indicate to the UE 102 a signal format of prediction window update request and response to be sent at 614 and 616, and the corresponding signaling channel.

At 606, the gNB 106 may be configured to send an indication message for the UE to start triggering ML model prediction window for the defined use case.

The triggering of the operation 606 may be linked to imminent HO process, and be linked to e.g. an A3 trigger indicating that a neighbour cell has become stronger than the serving cell by a specific offset and for a certain amount of time.

At 608, the UE may be configured to perform an inference to output a sequence of prediction samples in a future time window L_{pred}, ie., based on the prediction window length. The output may be provided, for example, in milliseconds (ms). The output may comprise, for example, beam/cell RSRP values from serving cells/beams and neighboring cells/beams within the configured prediction window. An implementation example of the ML model structure is depicted in FIG. 5 for mobility management and HO decision.

Optionally, at 610, the UE 102 may be configured to request to trigger the prediction window update evaluation procedures. The gNB 106 may be configured to send a response to the UE 102 based on the request.

The operation 610 may be optional because the triggering can be based on per execution of ML prediction in operation 608, which may be aligned with the prediction periodicity.

When the triggering communication between the UE 102 and the gNB 106 is used, a set of new timers can be set if the evaluation is triggered periodically.

At 612, the UE 102 and the gNB 106 may be configured to evaluate the prediction window length based on the prediction window update criteria and constraints.

The evaluation can be based on network system performance. For example, the evaluation may be performed based on one of the system KPIs recorded in the network level, Qₛ, with respect to the preconfigured threshold γₛ. In one example, a joint evaluation based on various objectives Qₛ can be considered with a corresponding vector of thresholds, γₛ.

In addition, or alternatively, the evaluation can be based on UE ML model reliability performance. For example, the evaluation may be performed based on one of the model reliability performance recorded in the UE level, Qₘ, with respect to the preconfigured threshold γₘ. The model reliability can be determined based on a prediction accuracy, i.e.,

$${Q}_{m} = \frac{Prediction}{Ground Truth} .$$

In one example, a joint evaluation based on various objectives Qₘ can be considered with a corresponding vector of thresholds, γₘ.

The evaluation may be implementation specific. However, the evaluation may be mainly executed via the interaction between the UE 102 and the gNB 106. Further, the evaluation criteria can be jointly constructed from both network level and UE level.

According to the evaluation outcome of the prediction window update criteria at 612, the UE 102 may be configured to send an indication message to the gNB 106 for prediction window length update request, at 614. Various options can be applied for this indication message.

For example, the evaluation outcome can be configured to be indicated with 1 bit information. According to the selected measure vs satisfactory ratio, the UE 102 may be configured to send message 1 or 0 to indicate whether the current prediction window length is sufficient or not. For example, when a single system KPI Qₛ is selected, then 1 may be generated by the UE 102 if Qₛ<γₛ, or vice versa.

The evaluation outcome can be also configured to be indicated, for example, with n-bit information. For example, when multiple measures are compared by the UE 102 against the predefined satisfactory thresholds, a generalized n-bit sequence indication may be sent from the UE 102 to the gNB 106.

The indication message may be sent, for example, via a L1/L2 signaling channel, e.g., MAC CE.

Alternatively, the UE 102 may not need to send the request for prediction window update at 614. For example, at 616, the gNB 106 can be configured to directly indicate for the UE 102 to execute the update process based on the evaluation outcome, especially when the network system performance-based evaluation is applied.

At 616, the gNB 106 may be configured to send an indication message to the UE 102 to trigger the prediction window length update for the next prediction interval/period. Alternatively, the gNB 106 may instruct the UE to continue using the current prediction window length, if there is no need for an update based on the evaluation result(s). The trigger may be sent in response to the prediction window update request, or based on evaluation performed by the gNB 106.

The gNB 106 may be configured to decide whether the UE 102 should perform the semi-static/dynamic adaptation with the predefined offset adjustment or trigger the full static reconfiguration process based on the assessment results at 612.

The gNB 106 may be configured to send the indication message, for example, via the L1/L2 signaling channel, e.g., MAC CE.

At 618, the UE 102 may be configured to update its prediction window length in time domain for the enabled ML model.

For example, the UE 102 may be configured to request to perform RRC reconfiguration the prediction window length update related information and operations based on the received indication message, and return to operation 602.

Alternatively, the UE 102 may be configured to perform the semi-static/dynamic prediction window length adaptation according to the indication message at 616. Hence, the UE 102 may be configured to perform the prediction window length update directly without reconfiguration messaging, for instance, by using a set of offset values {±Δ_{win},0}.

Instead of the rule-based mechanism and configuration for determining and updating the prediction window length, as illustrated in FIG. 6, the gNB 106 may be configured to use a ML model configured to output the prediction window length, for example, for every prediction interval.

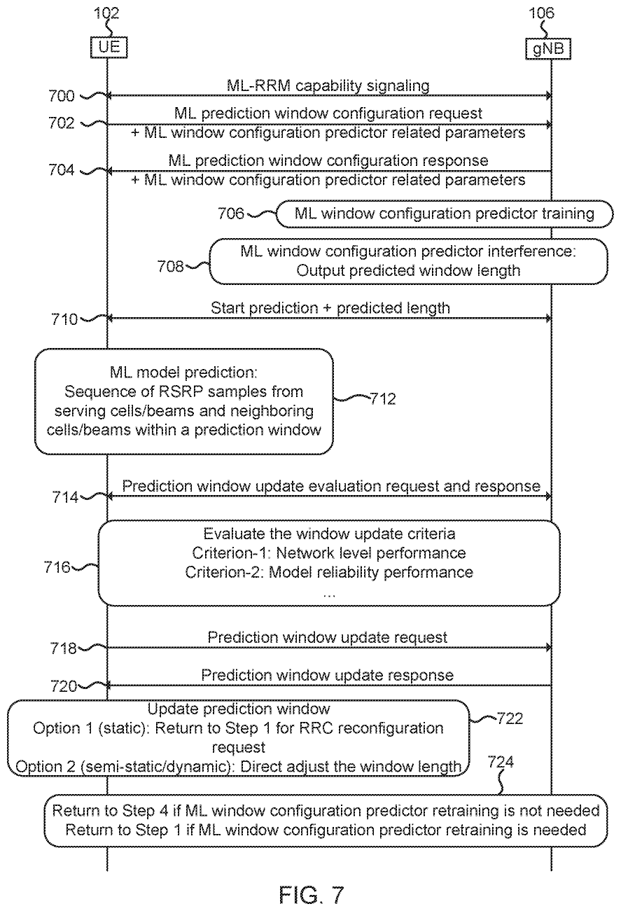

FIG. 7 illustrates an example of a message sequence chart for prediction window length update by using a ML window configuration predictor according to an example embodiment.

At 700, a user node, such as UE 102, and a network node, such as gNB 106, may be configured to perform capability exchange for ML-based radio algorithms. The UE 102 may be configured to request ML-based functionalities to support a target use case, e.g., LTM.

At 702, the UE 102 may be configured to request one or more configurations from the gNB 106 to be used for the execution of one or more ML prediction window update and optimization related procedures. The gNB 106 may be configured to respond to the UE 102 with the requested configuration message and relevant parameter settings, at 704. In an embodiment, the configuration request may be received via the capability exchange messaging.

The configuration message and sent prediction window configuration information may comprise the same as described for the rule-based mechanism in FIG. 6. The information may comprise, for example, ML model ID or ML-related algorithm ID to output window prediction samples for desired use cases at 712, and/or ML prediction window update criteria. The information may further comprise an indication of a prediction window length. However, the ML prediction window configuration related parameters of the rule-based mechanism may not be explicitly used in the configuration message. In this example case, another ML-related function, called ML window configuration predictor may be used to output the prediction window length L_{pred} for the UE to execute the window prediction at 712.

The UE 102 may be configured to provide some set of training data, such as a measurement report with one or more measurements, for the ML window configuration predictor. The UE 102 may be configured to transfer the data to the gNB 106 at 702 to provide any needed ML window configuration predictor related parameters for the gNB 106.

The gNB 106 may be configured to enable the use of ML window configuration predictor to generate the predicted window length L_{pred}. The gNB 106 may be configured to train the ML window configuration predictor at 706, for example, based on the training data provided by the UE 102. At 708, the gNB 106 obtains the predicted window length L_{pred} based on the ML window configuration predictor inference.

In one example, a model structure of the ML window configuration predictor may comprise historical data in terms of beam/cell RSRP samples, past window settings, UE speeds, position, etc., as an input. The model structure may further comprise neural network (NN) layers. The NN layers may comprise, for example, at least one of a LSTM (encoder), a LSTM (decoder), a dense layer and/or a Softmax activation function. The model structure may be configured to output a sliding prediction window length L_{pred}. The output may be in ms, or in any other configured time unit.

At 710, the gNB 106 may be configured to send an indication message for the UE 102 to start triggering ML model prediction window for the defined use case, e.g., LTM. In addition, the prediction window length to use, L_{pred}, may be also transferred to the UE based on the prediction outcome at 708.

At 712, the UE 102 may be configured to perform an inference with a ML model stored by the UE 102 to output a sequence of prediction samples. The prediction samples may be associated with serving cells/beams and neighboring cells/beams. The predictions may comprise, for example, beam/cell RSRP values in a future time window L_{pred} in ms. One implementation example of the model structure is depicted in FIG. 5 for mobility management and HO decision.

At 714, the UE 102 may be configured to request to trigger the prediction window update evaluation procedures. In addition, the gNB 106 may be configured to send response to the UE 102 based on the request.

The operation 714 may be optional because the triggering can be based on per execution of ML prediction at 708, which may be aligned with prediction periodicity.

When the triggering communication between the UE 102 and the gNB 106 is used, a set of new timers can be set if the evaluation is triggered periodically.

At 716, the UE 102 and the gNB 106 may be configured to evaluate the prediction window update criteria and constraints.

The implementation and evaluation operations may be formulated to be the same as for the rule-based mechanism, described with FIG. 6. The criteria can be based on at least one of network system performance and/or UE ML model reliability performance. A threshold or a set of thresholds may be used for update constraints assessment.

The evaluation may be implementation specific. However, the evaluation may be executed via the interaction between the UE 102 and the gNB 106. The evaluation criteria can be jointly constructed from both network level and UE level.

According to the evaluation out come of prediction window update criteria at 716, the UE 102 may be configured to send an indication message to the gNB 106 for prediction window length update request at 718. Various options can be applied for the indication message, similarly to the rule-based mechanism.

Alternatively, the UE 102 may not need to send the request for prediction window update. For example, the gNB 106 can be configured to directly indicate for the UE 102 to execute the update process, at 722, based on the evaluation outcome. The direct indication approach may be used especially when the network system performance is applied for the evaluation.

At 720, the gNB 106 may be configured to send an indication message to the UE 102 to trigger the prediction window length update for the next prediction interval/period. The trigger may be sent by the gNB 106 in response to at least one of the prediction window update request or based on evaluation performed by the gNB 106.

According to the evaluation assessment results at 716, the gNB 106 may be configured to decide whether the UE 102 should request a full reconfiguration message by returning to the operation 702. The reconfiguration may involve a model retraining phase for the ML window configuration predictor. Alternatively, the gNB 106 may be configured to decide based on the evaluations that the UE 102 should continue to use an output Lₑᵥₐₗ from the current ML window configuration predictor for a next interval.

Alternatively, the UE 102 may be configured to use the semi-static/dynamic approach in response to the indication message received from the gNB 106, similarly as in the rule-based mechanism with the set of offset values {±Δ_{win},0}.

The gNB 106 may be configured to send the indication message via a L1/L2 signaling channel, e.g., MAC CE.

At 722, the UE 102 may be configured to update the prediction window length in time domain for the enabled ML model.

For example, the UE 102 may be configured to request to perform the RRC reconfiguration at 702 for the prediction window length update related information and operations.

Alternatively, the UE 102 may be configured to perform the semi-static/dynamic prediction window length adaptation according to the indication message from operation 720. The UE 102 may be configured to directly update the prediction window length, for instance, by using the set of offset values {±Δ_{win},0}. The direct updating may mean that one or more of the previous operations may not need to be repeated, such as in the reconfiguration example.

At 724, the gNB 106 may be configured to determine if ML window configuration predictor retraining is needed. For example, the gNB 106 may determine to continue without retraining for the ML window configuration predictor. The gNB 106 may continue to use the current ML window configuration predictor to output Lₑᵥₐₗ for next interval. Alternatively, the gNB 106 may determine to proceed to initiate retraining for the ML window configuration predictor. For example, the gNB 106 may be configured to trigger the UE 102 to perform the RRC reconfiguration request at 702 for the prediction window length update related information. The gNB 106 may be then configured to retrain the ML window configuration predictor, for example, based on ML window configuration predictor related parameters received from the UE 102.

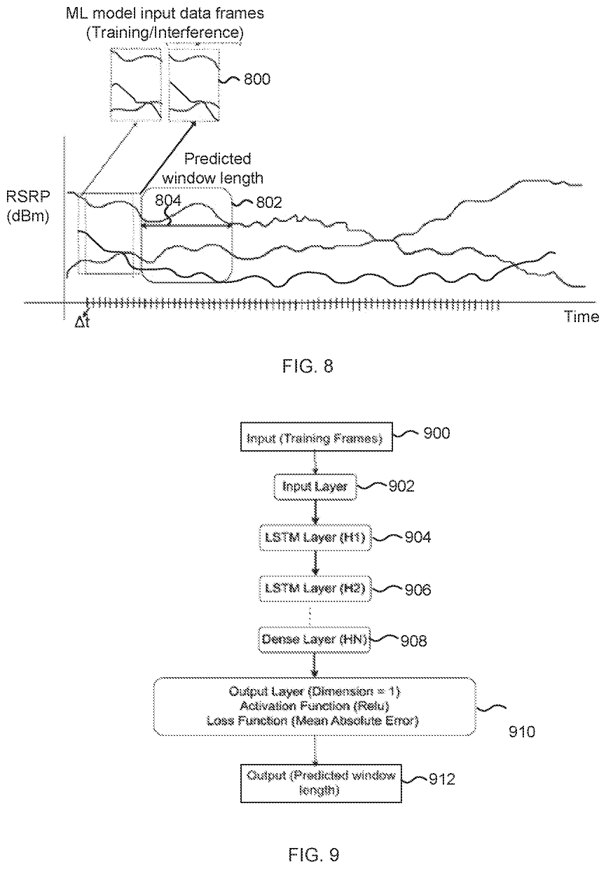

FIG. 8 illustrates an example application of a ML-based window configuration predictor for a window length prediction according to an example embodiment. The ML window configuration predictor may be deployed at a gNB side to collect RSRP measurements reported from a UE as an input 800. A desired prediction window length may be a length in which the environment is expected to be stable. An output of the ML model may be denoted by L_{pred} (for example, in ms). The output may be further applied by another ML model at the UE to predict a sequence of intended output, e.g., RSRP or beam IDs, within the prediction window L_{pred}.

A sliding prediction window of length X may be used to slide over the collected RSRP values, for example, from two cells. The cells may comprise, for example, a serving cell and a neighbor cell. However, the RSRP values may be also from more than two sources. For every sliding step forward, a new training frame 802 may be extracted as shown in FIG. 8. During training, a ground truth for the future window length during which the environment may stable remain is estimated. Estimation of the stability of the future environment may be done by simple signal levels comparisons or by using advanced correlation techniques. As an example, the stability can be verified if the signal strength is varying between a predefined range. The predicted future window length/duration 802 and a ground truth length of the window duration 804 is shown in FIG. 8 per one of the input frames from the sliding window.

FIG. 9 illustrates an example model structure of a ML window configuration predictor according to an example embodiment. The ML model may be a regression model using recurrent neural network (RNN) LSTM as one or more hidden layers 904, 906. The LSTM may be chosen due to time series nature of input data frames 900 received via an input layer 902 and a need for a neural network that may be able to detect and learn base patterns over a long time. The proposed model structure may have several hidden layers depending on the complexity of the input data frames 900, e.g., based on a higher number of cells measurements. The model structure may further comprise at least one dense layer 908 and an output layer 910. The output layer 910 may comprise an activation function, e.g., a rectified linear unit (ReLU). The output layer 910 may further comprise a loss function, such as a mean absolute error. An output 912 may comprise a predicted window length.

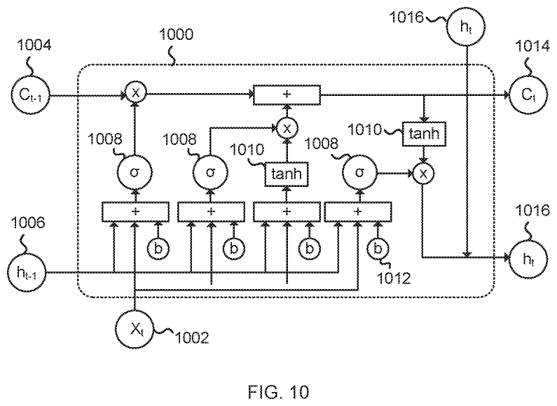

FIG. 10 illustrates an example of a structure of a single LSTM neural node 1000 within hidden layers of a ML model structure according to an example embodiment.

The LSTM may be configured to receive as an input a current input 1002, a stored memory from last LSTM unit (indicative of a cell state) 1004 and an output of last LSTM unit 1006 of the ML structure. One or more inputs 1002, 1004, 1006 may be combined and fed to one or more nonlinearities functions, such as to a sigmoid layer 1008 and/or a tanh (hyperbolic tangent) layer 1010. Before the nonlinearities function, a bias 1012 may be added to the input or a sum of inputs. Inputs and/or outputs from the nonlinearity functions may be scaled. Based on final outputs, the memory may be updated with a next cell state at 1014 and the output of the hidden layer may be provided to one or more next hidden layers at 1016.

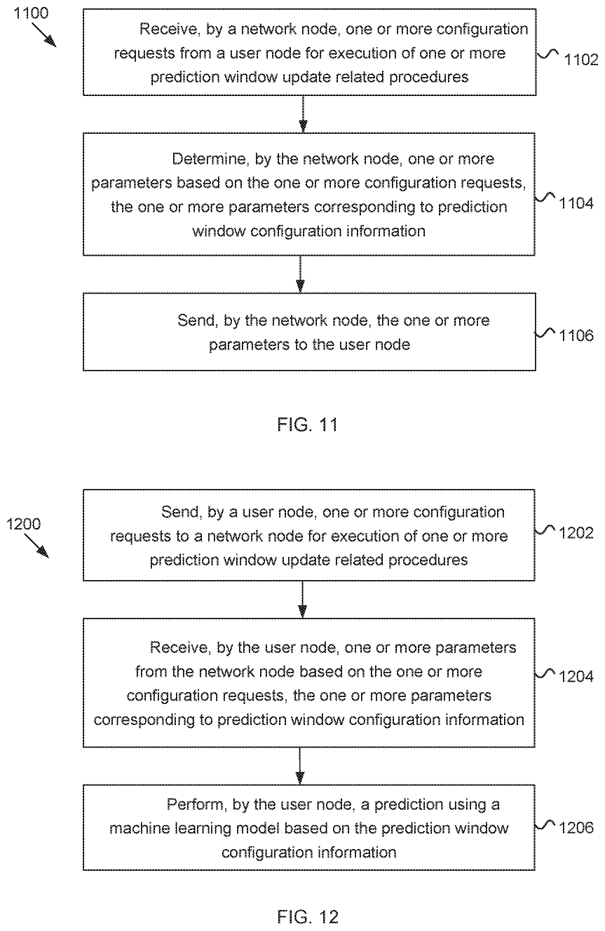

FIG. 11 illustrates an example of a method 1100 of enabling prediction window updates according to an example embodiment. The method may be performed, for example, by a computing device such as a network node.

At 1102, the method may comprise receiving, by the network node, one or more configuration requests from a user node for execution of one or more prediction window update related procedures.

At 1104, the method may comprise determining, by the network node, one or more parameters based on the one or more configuration requests, the one or more parameters corresponding to prediction window configuration information.

At 1106, the method may comprise sending, by the network node, the one or more parameters to the user node. The one or more parameter and included prediction window configuration information may be used by the user node, for example, for prediction using a machine learning model.

FIG. 12 illustrates an example of another method 1200 of enabling prediction window updates according to an example embodiment. The method may be performed, for example, by a computing device such as a user node.

At 1202, the method may comprise sending, by the user node, one or more configuration requests to a network node for execution of one or more prediction window update related procedures.

At 1204, the method may comprise receiving, by the user node, one or more parameters from the network node based on the one or more configuration requests, the one or more parameters corresponding to prediction window configuration information.

At 1206, the method may comprise performing, by the user node, a prediction using a machine learning model based on the prediction window configuration information.

Further features of the methods directly result from the functionalities and parameters of network node or the user node, as described in the appended claims and throughout the specification and are therefore not repeated here. It is noted that one or more operations of the method may be performed in different order.

An apparatus, for example a network node, a user node or a client node, may be configured to perform or cause performance of any aspect of the method(s) described herein. Further, a computer program may comprise instructions for causing, when executed, an apparatus to perform any aspect of the method(s) described herein. Further, an apparatus may comprise means for performing any aspect of the method(s) described herein. According to an example embodiment, the means comprises at least one processor, and memory including program code, the at one memory and the program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this circuitry also covers an application, the term implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A network node, comprising:
at least one processor; and
at least one memory including instructions which, when executed by the at least one processor, cause the network node at least to:
receive one or more configuration requests from a user node for execution of one or more prediction window update related procedures;
determine one or more parameters based on the one or more configuration requests, the one or more parameters corresponding to prediction window configuration information; and
send the one or more parameters to the user node.

2. The network node of claim 1, wherein the prediction window configuration information comprise at least one of an indication of a prediction window length, one or more criteria for evaluating the prediction window length, one or more thresholds for the one or more criteria, a prediction interval, an identifier of a machine learning model to be used by the user node for performing a prediction based on the prediction window configuration information, instructions for updating the prediction window length, or one or more adjustment parameters for updating the prediction window length.

3. The network node of claim 2, wherein the at least one memory further comprises instructions which, when executed by the at least one processor, cause the network node to:
obtain an evaluation result of the prediction window length based on the one or more criteria and the one or more thresholds, wherein the evaluation is at least one of received from the user node or performed by the network node; and
send a message to the user node based on the evaluation result, the message comprising instructions to trigger a prediction window length update for a next prediction interval or continue predictions with the prediction window length.

4. The network node of claim 3, wherein the at least one memory further comprises instructions which, when executed by the at least one processor, cause the network node to:
receive, from the user node, a request for evaluation of the prediction window length; and
send a response to the user node to initiate the evaluation.

5. The network node of claim 3, wherein the message is configured to trigger the user node to send a reconfiguration request for reconfiguration of the one or more parameters from the network node; and wherein the at least one memory further comprises instructions which, when executed by the at least one processor, cause the network node to:
receive the reconfiguration request from the user node;
determine one or more updated parameters based on the reconfiguration request; and
send the one or more updated parameters for the user node for the prediction window length update.

6. The network node of claim 3, wherein the message is configured to trigger the user node to perform the prediction window length update based on the one or more adjustment parameters.

7. The network node of claim 2, wherein the indication of a prediction window length comprises a predicted window length, and the at least one memory comprises instructions which, when executed by the at least one processor, cause the network node to configure a machine learning model to compute the predicted window length based on the one or more configuration requests.

8. The network node of claim 2, wherein the indication of a prediction window length comprises a rule for setting the prediction window length determined based on one or more radio communications related parameters.

9. The network node of claim 7, wherein at least one of the configuration request or the reconfiguration request comprises one or more measurements to be used by the network node for training the machine learning model configured to compute the predicted window length, and wherein the at least one memory comprises instructions which, when executed by the at least one processor, cause the network node to:
train the machine learning model based on the one or more measurements before sending the predicted window length.

10. A user node, comprising:
at least one processor; and
at least one memory including instructions which, when executed by the at least one processor, cause the user node at least to:
send one or more configuration requests to a network node for execution of one or more prediction window update related procedures;
receive one or more parameters from the network node based on the one or more configuration requests, the one or more parameters corresponding to prediction window configuration information; and
perform a prediction using a machine learning model based on the prediction window configuration information.

11. The user node of claim 10, wherein the prediction window configuration information comprise at least one of an indication of a prediction window length, one or more criteria for evaluating the prediction window length, one or more thresholds for the one or more criteria, a prediction interval, an identifier of the machine learning model, instructions for updating the prediction window length, or one or more adjustment parameters for updating the prediction window length.

12. The user node of claim 10, wherein the at least one memory further comprises instructions which, when executed by the at least one processor, cause the user node to:
receive a message from the network node, the message comprising instructions to trigger a prediction window length update for a next prediction interval or to continue prediction with the prediction window length based on an evaluation of the prediction window length; and
perform the prediction window length update when triggered by the message.

13. The user node of claim 12, wherein the at least one memory further comprises instructions which, when executed by the at least one processor, cause the user node to:
evaluate the prediction window length based on the one or more criteria and the one or more thresholds;
send an indication of the evaluation result to the network node; and
wherein the message from the network node is received in response to the sent evaluation result.

14. The user node of claim 13, wherein the indication of the evaluation result is provided as 1 bit information when the evaluation is performed based on a single criterion and as n-bit information when the evaluation is performed based on more than one criterion.

15. The user node of claim 13, wherein the at least one memory further comprises instructions which, when executed by the at least one processor, cause the user node to:
send a request for evaluation of the prediction window length to the network node; and
receive a response from the network node to trigger the evaluation.

16. The user node of claim 12, wherein the at least one memory comprises instructions which, when executed by the at least one processor, cause the user node to:
send a reconfiguration request for one or more parameters to the network node based on the received message;
receive from the network node the one or more updated parameters; and
update the prediction window length based on the one or more updated parameters.

17. The user node of claim 12, wherein the message comprises instructions to perform the prediction window length update based on the one or more adjustment parameters.

18. The user node of claim 11, wherein the indication of a prediction window length comprises a predicted window length, and at least one of the configuration request or the reconfiguration request comprises one or more measurements to be used by the network node for training a machine learning model configured to compute the predicted window length before sending the predicted window length.

19. (canceled)

20. A computer-implemented method, comprising:
sending, by a user node, one or more configuration requests to a network node for execution of one or more prediction window update related procedures;
receiving, by the user node, one or more parameters from the network node based on the one or more configuration requests, the one or more parameters corresponding to prediction window configuration information; and
performing, by the user node, a prediction using a machine learning model based on the prediction window configuration information.
